(19) United States
(12) Patent Application Publication
(10) Pub. No.: US 2024/0175981 A1
(43) Pub. Date: May 30, 2024

(54) SIGNAL GENERATION APPARATUS, SIGNAL GENERATION PROGRAM AND SIGNAL GENERATION METHOD

(71) Applicant: DENSO CORPORATION, Kariya-city (JP)

(72) Inventor: Tomihiro IKEGAMI, Kariya-city (JP)

(21) Appl. No.: 18/437,095

(22) Filed: Feb. 8, 2024

Related U.S. Application Data
(63) Continuation of application No. PCT/JP2022/030108, filed on Aug. 5, 2022.

(30) Foreign Application Priority Data
Aug. 11, 2021 (JP) 2021-131330

(51) Int. Cl. G01S 7/40

(52) U.S. Cl. CPC G01S 7/406

(57) ABSTRACT

A signal generation apparatus includes an extraction unit and a conversion unit. The extraction unit is configured to extract part of a frequency waveform as an extracted waveform. The frequency waveform is a waveform represented by a function of frequency. The part of the frequency waveform corresponds to frequencies satisfying a preset extraction condition indicating that amplitude of the frequency waveform is high. The conversion unit is configured to convert the extracted waveform extracted by the extraction unit into a time waveform, which is a waveform represented by a function of time, and generate the time waveform as a signal.

### CROSS-REFERENCE TO RELATED APPLICATIONS

The present application is a continuation application of International Application No. PCT/JP2022/030108 filed on Aug. 5, 2022, which is based on and claims priority from Japanese Patent Application No. 2021-131330 filed on August 11, 2021. The entire contents of these applications are incorporated by reference into the present application.

### BACKGROUND

### 1 Technical Field

The present disclosure relates to signal generation apparatuses, signal generation programs and signal generation methods.

### 2 Description of Related Art

There are known signal generation apparatuses that generate signals using an inverse Fourier transform (see, for example, Japanese Unexamined Patent Application Publication No. JP 2011-205557 A).

### SUMMARY

According to one aspect of the present disclosure, there is provided a signal generation apparatus which includes an extraction unit and a conversion unit. The extraction unit is configured to extract part of a frequency waveform as an extracted waveform. The frequency waveform is a waveform represented by a function of frequency. The part of the frequency waveform corresponds to frequencies satisfying a preset extraction condition indicating that amplitude of the frequency waveform is high. The conversion unit is configured to convert the extracted waveform extracted by the extraction unit into a time waveform, which is a waveform represented by a function of time, and generate the time waveform as a signal.

According to another aspect of the present disclosure, there is provided a signal generation program for causing a computer to function as the extraction unit and the conversion unit.

According to yet another aspect of the present disclosure, there is provided a signal generation method comprising: extracting part of a frequency waveform as an extracted waveform, the frequency waveform being a waveform represented by a function of frequency, the part of the frequency waveform corresponding to frequencies satisfying a preset extraction condition indicating that amplitude of the frequency waveform is high; converting the extracted waveform into a time waveform which is a waveform represented by a function of time; and generating the time waveform as a signal.

### BRIEF DESCRIPTION OF THE DRAWINGS

FIG. 1 is a block diagram illustrating the configuration of a radar simulator.

FIG. 2 is a flowchart illustrating a reception wave generation process.

FIG. 3 is a diagram illustrating a specific example of a two-dimensional Fourier spectrum.

FIG. 4 is a diagram showing an extracted spectrum array and a reception wave generated based on the extracted spectrum array.

FIG. 5 is a graph illustrating the relationship between the calculation time required for generating a reception wave and the number of waves.

FIG. 6 is a diagram illustrating a procedure for generating a reception wave by adding a plurality of time waveforms together.

FIG. 7 is a diagram showing an extraction rectangle and an extraction circle.

FIG. 8 is a diagram illustrating a method of generating a time waveform from a one-dimensional Fourier spectrum.

### DESCRIPTION OF EMBODIMENTS

In the case of generating a time waveform represented by a function of time, a method is generally used in which a plurality of time waveforms having mutually different frequencies are added together. With this method, the calculation time increases in proportion to both the number of sample points in each time waveform and the number of the time waveforms; consequently, the time required for the signal generation is increased.

Moreover, as a result of a detailed investigation by the inventor of the present application, problems have been found that: in the case of generating a signal by performing calculation for converting frequency waveforms represented by functions of frequency into a time waveform using an inverse Fourier transform, the calculation time increases in proportion to both the number of sample points in the frequency waveforms and the number of the frequency waveforms; further, due to the addition of the processing time of the inverse Fourier transform, the time required for the signal generation is further increased.

The present disclosure has been accomplished in view of the above problems.

The above-described signal generation apparatus according to the present disclosure extracts the high-amplitude part of the frequency waveform as the extracted waveform and performs calculation for converting the extracted waveform into the time waveform. Consequently, it becomes possible to shorten the time required for the calculation performed for converting the frequency waveform into the time waveform. Moreover, since the signal generation apparatus according to the present disclosure extracts the high-amplitude part of the frequency waveform and converts it into the time waveform, it becomes possible to generate the signal so that the difference between the time waveform and a time waveform generated by converting the entire frequency waveform is small.

Moreover, a computer controlled by the above-described signal generation program according to the present disclosure can constitute a part of the signal generation apparatus according to the present disclosure, and thus can achieve the same advantageous effects as achievable with the signal generation apparatus according to the present disclosure.

Furthermore, the above-described signal generation method according to the present disclosure is a method carried out by the signal generation apparatus according to the present disclosure. Therefore, by carrying out the signal generation method, it is possible to achieve the same advantageous effects as achievable with the signal generation apparatus according to the present disclosure.

Hereinafter, an exemplary embodiment of the present disclosure will be described with reference to the drawings.

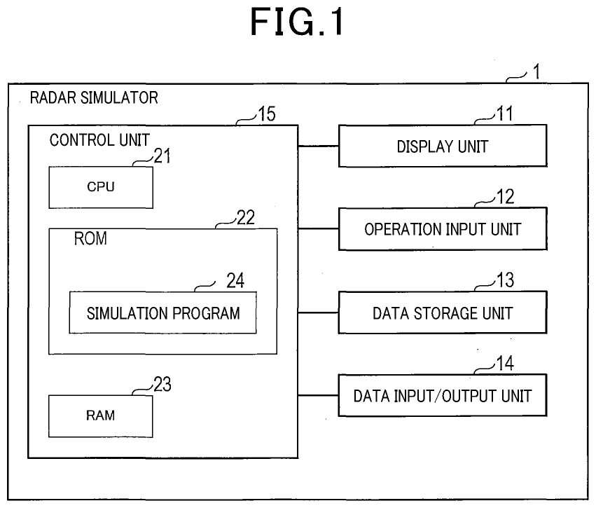

As shown in FIG. 1, a radar simulator 1 according to the present embodiment includes a display unit 11, an operation input unit 12, a data storage unit 13, a data input/output unit 14 and a control unit 15.

The display unit 11 includes a display device that is not shown in the drawings, and displays various images on a display screen of the display device.

The operation input unit 12 outputs input operation information for specifying input operations performed by a user via a keyboard and a mouse, neither of which is shown in the drawings.

The data storage unit 13 is a storage device for storing various data.

The data input/output unit 14 performs input/output of data between the radar simulator 1 and an external device that is connected with the radar simulator 1 in a wired or wireless manner.

The control unit 15 is constituted mainly of a microcomputer which includes a CPU 21, a ROM 22 and a RAM 23. Various functions of the microcomputer are realized by the CPU 21 executing programs stored in a non-transitory tangible recording medium. In this example, the ROM 22 corresponds to the non-transitory tangible recording medium in which the programs are stored. Moreover, through the execution of the programs, methods corresponding to the programs are carried out. It should be noted that some or all of the functions executed by the CPU 21 may alternatively be realized in hardware by, for example, one or more ICs. It also should be noted that the control unit 15 may be constituted of only a single microcomputer or a plurality of microcomputers.

In the ROM 22, there is stored a simulation program 24. It should be noted that the simulation program 24 may be installed in the radar simulator 1 in advance, or may be installed via a recording medium or a network. Examples of the recording medium include an optical disk, a magnetic disk and a semiconductor memory.

The simulation program 24 is configured to reproduce, in a virtual space, the three-dimensional shape of a road and the three-dimensional shapes of surroundings of the road using high-accuracy three-dimensional map data, and to make a vehicle travel on the road reproduced in the virtual space. Moreover, the simulation program 24 is configured to simulate the transmission/reception of radar waves by a radar device installed in the vehicle traveling in the virtual space.

A radar simulation, which simulates the traveling of the vehicle and the transmission/reception of radar waves by the radar device, is executed by activating the simulation program 24 stored in the ROM 22.

Next, the procedure of a reception wave generation process for generating a radar wave received by the radar device in the radar simulation (hereinafter, to be referred to as reception wave) will be described.

Each time a transmission wave generation process is executed for generating radar waves transmitted by the radar device in the radar simulation (hereinafter, to be referred to as transmission waves), the reception wave generation process is started after completion of the transmission wave generation process. In addition, the transmission wave generation process is executed each time a preset radar wave transmission period elapses in the virtual space created by the radar simulation.

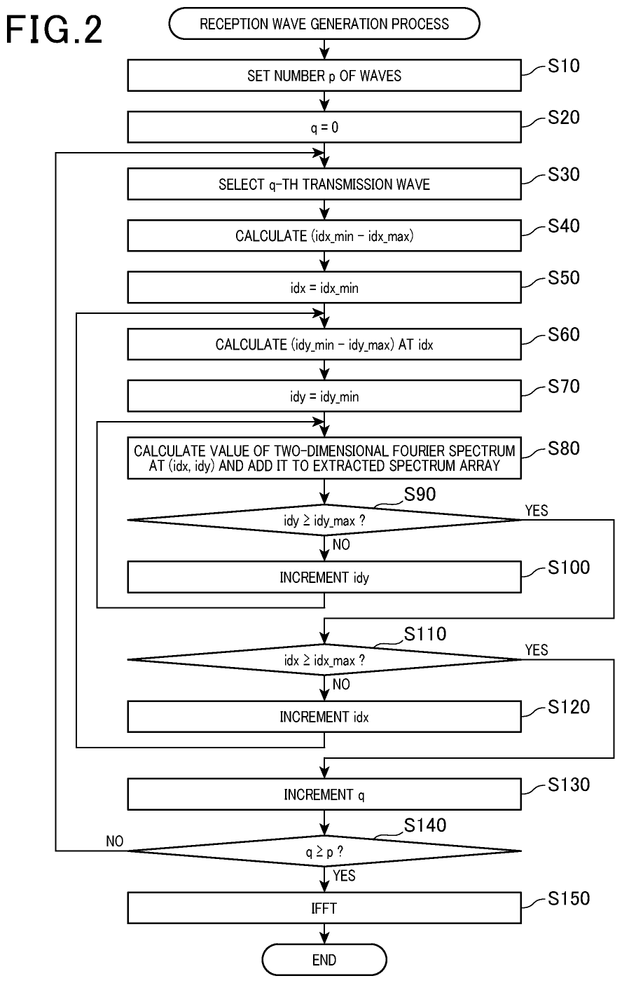

When the reception wave generation process is executed, as shown in FIG. 2, first, in step S10, the CPU 21 of the control unit 15 sets the number p of transmission waves in the RAM 23. Specifically, the CPU 21 stores a value, which represents the number of transmission waves generated in the latest transmission wave generation process, in the number p of transmission waves.

Next, in step S20, the CPU 21 stores 0 in a transmission wave identification number q in the RAM 23.

Further, in step S30, the CPU 21 selects the q-th transmission wave among the one or more transmission waves generated in the latest transmission wave generation process.

Then, in step S40, the CPU 21 calculates an X-axis direction index range (idx_min-idx_max) for the two-dimensional Fourier spectrum of the radar wave that is generated by the reflection of the q-th transmission wave by an object and received by the radar device (hereinafter, to be referred to as the q-th reception wave).

Here, the process in step S40 will be specifically described.

In the present embodiment, the two-dimensional Fourier spectrum of a reception wave is defined by Equation (1).

In Equation (1), F is a component of the two-dimensional Fourier spectrum, A is the maximum amplitude of the q-th reception wave, ϕ is the phase of the q-th reception wave and f is the frequency of the q-th reception wave. Moreover, idx is an integer in the range of (0-255); and idy is an integer in the range of (0-1023). Furthermore, W=256; and H=1024.

$$F = A {e}^{j ϕ} \frac{1 - {e}^{j 2 π f}}{1 - {e}^{j 2 π ( f - i dx ) / W}} \frac{1 - {e}^{j 2 π H f}}{1 - {e}^{j 2 π ( f - idy / H )}} \qquad ( 1 )$$

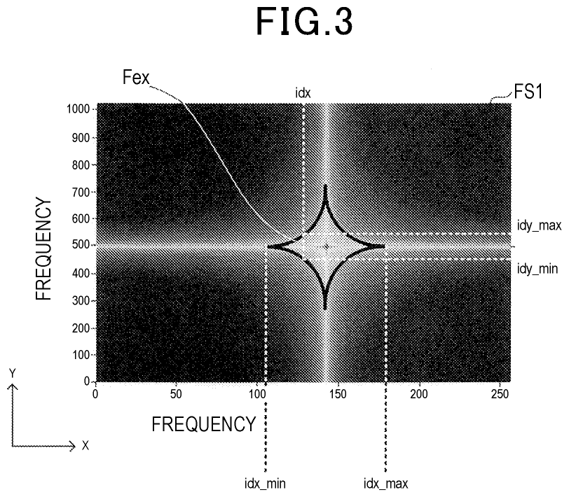

The two-dimensional Fourier spectrum FS1 shown in FIG. 3 is a specific example of the two-dimensional Fourier spectrum of a reception wave. The X axis of the two-dimensional Fourier spectrum FS1 represents frequency corresponding to the speed of the object that reflected the radar wave; and the Y axis of the two-dimensional Fourier spectrum FS1 represents frequency corresponding to the distance of the object that reflected the radar wave.

First, the CPU 21 determines, based on the results of the radar simulation, the maximum amplitude A, phase ϕ and frequency f of the two-dimensional Fourier spectrum of the q-th reception wave. In addition, the maximum amplitude A, phase ϕ and frequency f of the two-dimensional Fourier spectrum of the q-th reception wave is determined based on the type and position of the object that reflected the q-th transmission wave.

Then, as shown in the two-dimensional Fourier spectrum FS1 in FIG. 3, the CPU 21 calculates the minimum value of the X-axis direction position at which the amplitude of the two-dimensional Fourier spectrum is higher than or equal to a preset extraction determination value as the X-axis direction index minimum value idx_min in Equation (1) into which the determined maximum amplitude A, phase ϕ and frequency f are substituted. Further, the CPU 21 calculates the maximum value of the X-axis direction position at which the amplitude of the two-dimensional Fourier spectrum is higher than or equal to the preset extraction determination value as the X-axis direction index maximum value idx_max. In addition, in the region inside the extraction figure Fex in the two-dimensional Fourier spectrum FS1, the amplitude of the two-dimensional Fourier spectrum is higher than or equal to the extraction determination value.

Upon completion of the process in step S40, as shown in FIG. 2, in step S50, the CPU 21 stores the X-axis direction index minimum value idx_min calculated in step S40 in an X-axis direction position idx in the RAM 23.

Next, in step S60, the CPU 21 calculates a Y-axis direction index range (idy_min-idy_max) at the X-axis direction position idx. That is, the CPU 21 calculates the Y-axis direction index minimum value idy_min and the Y-axis direction index maximum value idy_max. Specifically, as shown in FIG. 3, the CPU 21 calculates the minimum value of the Y-axis direction position at which the amplitude of the two-dimensional Fourier spectrum is higher than or equal to the extraction determination value as the Y-axis direction index minimum value idy_min at the X-axis direction position idx. Further, the CPU 21 calculates the maximum value of the Y-axis direction position at which the amplitude of the two-dimensional Fourier spectrum is higher than or equal to the extraction determination value as the Y-axis direction index maximum value idy_max at the X-axis direction position idx.

Upon completion of the process in step S60, as shown in FIG. 2, in step S70, the CPU 21 stores the Y-axis direction index minimum value idy_min calculated in step S60 in a Y-axis direction position idy in the RAM 23.

Then, in step S80, the CPU 21 calculates the value of the two-dimensional Fourier spectrum at the point (idx, idy) based on Equation (1), and adds the calculated value at the point (idx, idy) to an extracted spectrum array.

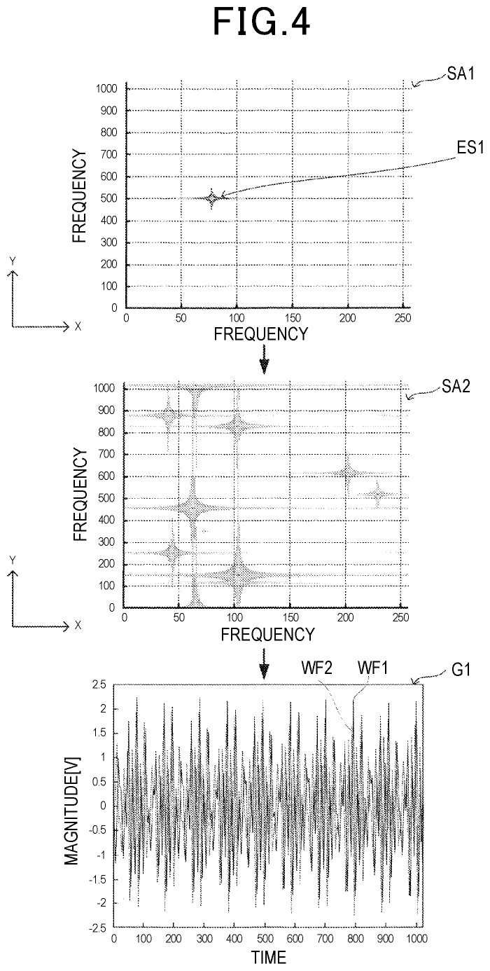

The extracted spectrum array represents, for example as represented by an extracted spectrum array SA1 in FIG. 4, the value of the two-dimensional Fourier spectrum expressed by Equation (1), with the X axis representing frequency corresponding to the speed of the object that reflected the radar wave and the Y axis representing frequency corresponding to the distance of the object that reflected the radar wave.

In the extracted spectrum array, in an initial state, the value is set to 0 at all (idx, idy). Then, each time the value is added at the point (idx, idy) in step S80, the value at the point (idx, idy) is increased by the added value.

The extracted Fourier spectrum ES1 in the extracted spectrum array SA1 in FIG. 4 is a part of the two-dimensional Fourier spectrum of a reception wave where the amplitude of the two-dimensional Fourier spectrum is higher than or equal to the extraction determination value.

Upon completion of the process in step S80, as shown in FIG. 2, in step S90, the CPU 21 determines whether the value stored in the Y-axis direction position idy is greater than or equal to the Y-axis direction index maximum value idy_max calculated in step S60. If the value stored in the Y-axis direction position idy is determined to be less than the Y-axis direction index maximum value idy_max, the process proceeds to step S100. In step S100, the CPU 21 increments the Y-axis direction position idy. That is, the CPU 21 stores a value, which is obtained by adding 1 to the value stored in the Y-axis direction position idy, in the Y-axis direction position idy. Then, the process returns to step S80.

On the other hand, if the value stored in the Y-axis direction position idy is determined to be greater than or equal to the Y-axis direction index maximum value idy_max, the process proceeds to step S110. In step S110, the CPU 21 further determines whether the value stored in the X-axis direction position idx is greater than or equal to the X-axis direction index maximum value idx_max calculated in step S40. If the value stored in the X-axis direction position idx is determined to be less than the X-axis direction index maximum value idx_max, the process proceeds to step S120. In step S120, the CPU 21 increments the X-axis direction position idx. That is, the CPU 21 stores a value, which is obtained by adding 1 to the value stored in the X-axis direction position idx, in the X-axis direction position idx. Then, the process returns to step S60.

On the other hand, if the value stored in the X-axis direction position idx is determined to be greater than or equal to the X-axis direction index maximum value idx_max, the process proceeds to step S130. In step S130, the CPU 21 increments the transmission wave identification number q. That is, the CPU 21 adds 1 to the value stored in the transmission wave identification number q. Then, in step S140, the CPU 21 further determines whether the value stored in the transmission wave identification number q is greater than or equal to the value stored in the number p of transmission waves.

If the value stored in the transmission wave identification number q is determined to be less than the value stored in the number p of transmission waves, the process returns to step S30. On the other hand, if the value stored in the transmission wave identification number q is determined to be greater than or equal to the value stored in the number p of transmission waves, the process proceeds to step S150. In step S150, the CPU 21 generates a reception wave by performing an inverse fast Fourier transform (IFFT) on the extracted spectrum array that is obtained by adding the value of the two-dimensional Fourier spectrum in step S80. Then, the CPU 21 terminates the reception wave generation process.

The extracted spectrum array SA2 in FIG. 4 is an example of the result of extracting the two-dimensional Fourier spectra located inside the extraction circles for all of the 0th to the (p-1)th reception waves.

The graph G1 in FIG. 4 illustrates the change with time of the reception wave generated by performing the inverse fast Fourier transform on the extracted spectrum array. The time waveform WF1 in the graph G1 represents the change with time of the real part of the generated reception wave. In contrast, the time waveform WF2 in the graph G1 represents the change with time of the imaginary part of the generated reception wave.

The radar simulator 1 configured as described above extracts part of a two-dimensional Fourier spectrum as an extracted spectrum array. The two-dimensional Fourier spectrum is a waveform represented by a function of frequency. The part of the two-dimensional Fourier spectrum corresponds to frequencies satisfying a preset extraction condition indicating that the amplitude of the two-dimensional Fourier spectrum is high. More particularly, in the present embodiment, the extraction condition is that the amplitude of the two-dimensional Fourier spectrum is higher than or equal to the extraction determination value.

Moreover, the radar simulator 1 converts the extracted spectrum array into a time waveform, which is a waveform represented by a function of time, and generates the time waveform as a signal.

Since the above radar simulator 1 extracts the high-amplitude part of the two-dimensional Fourier spectrum as the extracted spectrum array and performs calculation for converting the extracted spectrum array into the time waveform, it becomes possible to shorten the time required for the calculation performed for converting the frequency waveform into the time waveform. Moreover, since the radar simulator 1 extracts the high-amplitude part of the frequency waveform and converts it into the time waveform, it becomes possible to generate the signal so that the difference between the time waveform and a time waveform generated by converting the entire frequency waveform is small.

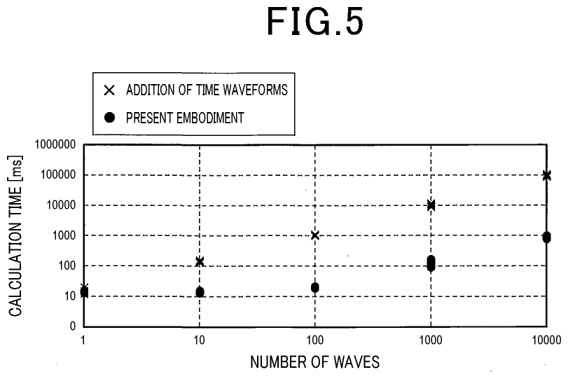

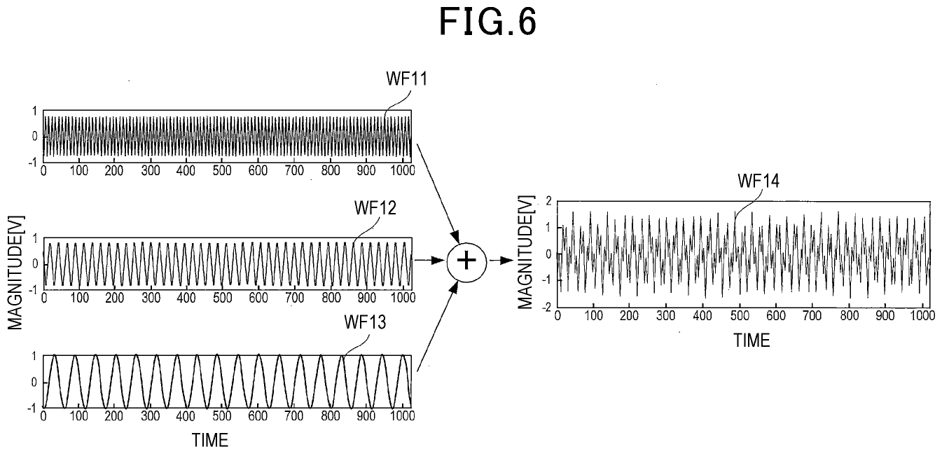

FIG. 5 is a diagram comparing the calculation time required for generating a reception wave according to the present embodiment and the calculation time required for generating the reception wave by adding a plurality of time waveforms together as shown in FIG. 6, varying the number of transmission waves (i.e., the number of waves).

FIG. 6 illustrates an example where three time waveforms WF11, WF12 and WF13 having mutually different frequencies are added together to generate the waveform WF14 of a reception wave.

As shown in FIG. 5, when the number of waves is 1, there is almost no difference in the calculation time between the present embodiment and the case of generating the reception wave by adding a plurality of time waveforms together. However, when the number of waves is 10, 100, 1000 or 10000, the calculation time according to the present embodiment becomes about 10 to 100 times shorter than the calculation time in the case of generating the reception wave by adding a plurality of time waveforms together.

In the above-described embodiment, the radar simulator 1 corresponds to a signal generation apparatus; the simulation program 24 corresponds to a signal generation program; steps S10 to S140 together correspond to the process performed by an extraction unit; and step S150 corresponds to the process performed by a conversion unit.

Moreover, the two-dimensional Fourier spectrum corresponds to a frequency waveform; the extracted spectrum array corresponds to an extracted waveform; and the amplitude of the two-dimensional Fourier spectrum corresponds to an extraction parameter.

While the above embodiment of the present disclosure has been described, it will be understood by those skilled in the art that the present disclosure is not limited to the above embodiment, but may be carried out through various modifications.

### [First Modification]

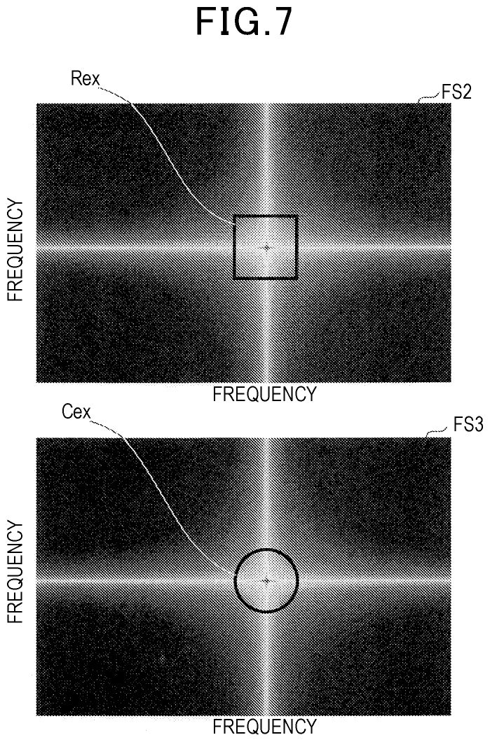

For example, in the above embodiment, the extraction condition is that the amplitude of the two-dimensional Fourier spectrum is higher than or equal to the extraction determination value. However, for example as shown in the two-dimensional Fourier spectrum FS2 in FIG. 7, the extraction condition may alternatively be that the frequencies satisfying the extraction condition are included in an extraction figure that is preset to include a frequency at which the amplitude of the two-dimensional Fourier spectrum reaches a peak (hereinafter, to be referred to as peak frequency). Moreover, the extraction figure in the two-dimensional Fourier spectrum FS2 is an extraction rectangle Rex. However, the shape of the extraction figure that is preset to include the peak frequency is not limited to a rectangle, but may alternatively be, for example, a circle such as an extraction circle Cex in the two-dimensional Fourier spectrum FS3 in FIG. 7.

### [Second Modification]

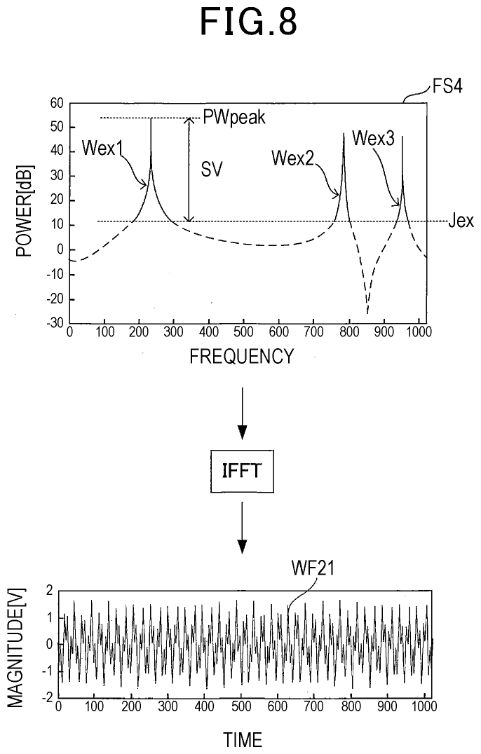

In the above embodiment, that part of the two-dimensional Fourier spectrum which corresponds to the frequencies satisfying the preset extraction condition is extracted as the extracted spectrum array. However, the frequency waveform is not limited to the two-dimensional spectrum, but may alternatively be a one-dimensional spectrum as shown in FIG. 8 or a three-dimensional spectrum.

### [Third Modification]

In the above embodiment, the extraction condition is that the amplitude of the two-dimensional Fourier spectrum is higher than or equal to the extraction determination value. However, for example as shown in FIG. 8, in a one-dimensional Fourier spectrum FS4 in which the horizontal axis represents frequency and the vertical axis represents power, the extraction condition may alternatively be that the power is higher than or equal to a preset post-subtraction extraction determination value Jex. The post-subtraction extraction determination value Jex is a value obtained by subtracting a preset subtraction value SV from a peak power PWpeak. The peak power PWpeak is the power at a frequency where the power reaches a peak in the one-dimensional Fourier spectrum FS4.

FIG. 8 illustrates that: extracted waveforms Wex1, Wex2 and Wex3 are extracted from the one-dimensional Fourier spectrum FS4; and the waveform WF21 of a reception wave is generated by performing an inverse fast Fourier transform (IFFT) on the extracted waveforms Wex1, Wex2 and Wex3.

In addition, in this modification, the power corresponds to an extraction parameter; and the peak power PWpeak corresponds to a peak parameter.

### [Fourth Modification]

In the above embodiment, the extraction parameter is the amplitude of the two-dimensional Fourier spectrum. However, the extraction parameter is not limited to the amplitude, but may alternatively be a parameter that has a positive correlation with the magnitude of the amplitude. For example, as shown in the one-dimensional Fourier spectrum FS4 in FIG. 8, the power may be used as the extraction parameter.

### [Fifth Modification]

In the above embodiment, the signal is generated using the inverse Fourier transform. However, other conversion methods, such as a wavelet transform, may alternatively be used to convert the frequency waveform into the time waveform.

### [Sixth Modification]

In the above embodiment, the radar wave is generated as the signal. However, the signal is not limited to the radar wave, but may alternatively be, for example, an audio signal.

The control unit 15 and the method described in the present disclosure may be realized by a dedicated computer that is configured with a processor, which is programed to execute one or more functions embodied by a computer program, and a memory. As an alternative, the control unit 15 and the method described in the present disclosure may be realized by a dedicated computer that is configured with a processor constituted of one or more dedicated hardware logic circuits. As another alternative, the control unit 15 and the method described in the present disclosure may be realized by one or more dedicated computers that are configured with a combination of a processor programed to execute one or more functions, a memory and a processor constituted of one or more hardware logic circuits. Moreover, the computer program may be stored, as computer-executable instructions, in a computer-readable non-transitory tangible recording medium. Furthermore, the functions of the control unit 15 are not necessarily realized by software; alternatively, all the functions may be realized by one or more pieces of hardware.

In the above embodiment, a plurality of functions performed by a single component may alternatively be performed respectively by a plurality of components; and a single function performed by a single component may alternatively be performed by a plurality of components. Conversely, a plurality of functions performed respectively by a plurality of components may alternatively be performed by a single component; and a single function performed by a plurality of components may alternatively be performed by a single component. Moreover, part of the configuration of the above embodiment may be omitted. Furthermore, at least part of the configuration of the above embodiment may be added to or replaced with configurations of other embodiments.

In addition to the radar simulator 1 described above, the present disclosure may be realized in various forms such as a system that includes the radar simulator 1 as a component thereof, a program for causing a computer to function as the radar simulator 1, a non-transitory tangible recording medium (e.g., a semiconductor memory) in which the program is recorded, and a signal generation method.

What is claimed is:

1. A signal generation apparatus comprising:
an extraction unit configured to extract part of a frequency waveform as an extracted waveform, the frequency waveform being a waveform represented by a function of frequency, the part of the frequency waveform corresponding to frequencies satisfying a preset extraction condition indicating that amplitude of the frequency waveform is high; and
a conversion unit configured to convert the extracted waveform extracted by the extraction unit into a time waveform, which is a waveform represented by a function of time, and generate the time waveform as a signal.

2. The signal generation apparatus as set forth in claim 1, wherein
the extraction condition is that an extraction parameter having a positive correlation with the magnitude of the amplitude of the frequency waveform is greater than or equal to a preset extraction determination value.

3. The signal generation apparatus as set forth in claim 1, wherein
in the frequency waveform, an extraction parameter having a positive correlation with the magnitude of the amplitude of the frequency waveform reaches a peak at a frequency,
the extraction parameter at the frequency where it reaches the peak is defined as a peak parameter,
a value which is obtained by subtracting a preset subtraction value from the peak parameter is defined as a post-subtraction extraction determination value, and
the extraction condition is that the extraction parameter of the frequency waveform is greater than or equal to the post-subtraction extraction determination value.

4. The signal generation apparatus as set forth in claim 1, wherein
in the frequency waveform, a frequency at which an extraction parameter having a positive correlation with the magnitude of the amplitude of the frequency waveform reaches a peak is defined as a peak frequency, and
the extraction condition is that the frequencies satisfying the extraction condition are included in an extraction figure that is preset in the frequency waveform to include the peak frequency.

5. A signal generation program for causing a computer to function as:
an extraction unit configured to extract part of a frequency waveform as an extracted waveform, the frequency waveform being a waveform represented by a function of frequency, the part of the frequency waveform corresponding to frequencies satisfying a preset extraction condition indicating that amplitude of the frequency waveform is high; and
a conversion unit configured to convert the extracted waveform extracted by the extraction unit into a time waveform, which is a waveform represented by a function of time, and generate the time waveform as a signal.

6. A signal generation method comprising:
extracting part of a frequency waveform as an extracted waveform, the frequency waveform being a waveform represented by a function of frequency, the part of the frequency waveform corresponding to frequencies satisfying a preset extraction condition indicating that amplitude of the frequency waveform is high;
converting the extracted waveform into a time waveform which is a waveform represented by a function of time; and
generating the time waveform as a signal.
